(19) United States
(12) Patent Application Publication
(10) Pub. No.: US 2006/0183879 A1
(43) Pub. Date: Aug. 17, 2006

(54) Process for producing a naphthalenesulfonate formaldehyde condensate

(75) Inventors: Fujio Yamato, Wakayama-shi (JP); Shuichi Fujita, Wakayama-shi (JP)

Correspondence Address: BIRCH STEWART KOLASCH & BIRCH, PO BOX 747, FALLS CHURCH, VA, 22040-0747, US

(73) Assignee: Kao Corporation, Tokyo (JP)

(21) Appl. No.: 11/341,633

(22) Filed: Jan. 30, 2006

(30) Foreign Application Priority Data
Jan. 31, 2005 (JP) 2005-023965

(51) Int. Cl. C08G 14/02

(52) U.S. Cl. 528/129

(57) ABSTRACT

The invention provides a process capable of easily producing a water-soluble salt of a naphthalenesulfonate formaldehyde condensate with a reduced amount of unreacted formaldehyde. When naphthalenesulfonic acid is subjected to condensation reaction with formaldehyde to produce a naphthalenesulfonate formaldehyde condensate, a sulfite is added to the reaction system after the conclusion of the condensation reaction. When a cement dispersant composition is obtained, the process includes a step of neutralizing the condensate.

### TECHNICAL FIELD

The present invention relates to a process for producing a naphthalenesulfonate formaldehyde condensate, a naphthalenesulfonate formaldehyde condensate produced by the process or a water-soluble salt thereof, a cement dispersant containing the same, and a cement composition having the same added thereto.

### BACKGROUND OF THE INVENTION

A water-soluble salt of a naphthalenesulfonic acid/formaldehyde condensate (also referred to hereinafter as naphthalene-based condensate salt) is a polymer produced by condensation reaction with formaldehyde, and has been used often in cement dispersants (JP-B 41-11737, “Cement Gijutsu Nenpo 1964, Cement Bunsanzai Ni Kansuru Kenkyu” (Cement Technology Annual Report 1964, Study on Cement Dispersant), pp. 200-204). When the naphthalene-based condensate salt is added as a cement dispersant to a cement composition, the fluidity of the composition is increased. As a result, preferable effects such as a decrease in the water cement ratio of the cement composition and an increase in concrete strength are known to be exhibited.

JP-A 4-211046 and JP-A 5-320120 disclose a reduction in free or unreacted formalin in production of naphthalenesulfonate formaldehyde condensates.

In recent years, the sick house syndrome caused by formaldehyde becomes problematic, and it is estimated that unreacted formaldehyde remaining in the naphthalene-based condensate salt becomes problematic from now on. A cement dispersant containing such naphthalene-based condensate salt or a cement composition containing the same is expected to be applicable as a product having stabilized qualities, reducing the amount of formaldehyde released from its hardened product, and less burdening the environment with a load.

### SUMMARY OF THE INVENTION

The present invention relates to a process for producing a naphthalenesulfonate formaldehyde condensate, that is, a condensate of naphthalenesulfonic acid and formaldehyde, including a condensation reaction step (I) of condensation-reacting naphthalenesulfonic acid with formaldehyde, a step (II) of adding a sulfite to the reaction system containing the condensate obtained in the condensation reaction step (I), and a step (III) of removing a water-insoluble material from the reaction system in the step (II).

The present invention also relates to a process for producing a water-soluble salt of a naphthalenesulfonate formaldehyde condensate, including the above shown steps (I) to (III), neutralization of the condensate being carried out after the condensation reaction step (I).

Also, the present invention relates to a naphthalenesulfonate formaldehyde condensate or a water-soluble salt thereof, which is obtainable by the process of the invention described above, a cement dispersant containing the water-soluble salt of a naphthalenesulfonic acid/formaldehyde condensate, and a cement composition containing cement, water and the cement dispersant.

Further, the present invention relates to a process for producing a cement dispersant, including a condensation reaction step (I) of condensation-reacting naphthalenesulfonic acid with formaldehyde, a step (II) of adding a sulfite to a reaction system containing the condensate obtained in the condensation reaction step (I), and a step (III) of removing a water-insoluble material from the reaction system in the step (II), neutralization of the condensate being carried out after the condensation reaction step (I).

In addition, the present invention relates to a cement dispersant containing a naphthalenesulfonate formaldehyde condensate containing 110 mg/kg or less, or 110 ppm or less, of formaldehyde and having a weight-average molecular weight of 10000 or more, or a water-soluble salt thereof.

### DETAILED DESCRIPTION OF THE INVENTION

In the condensation reaction of naphthalenesulfonic acid with formaldehyde, (1) a reduction in the ratio of formaldehyde to be charged, (2) an increase in the degree of conversion of formaldehyde by increasing the reaction temperature, etc., can be anticipated as a method of reducing the amount of unreacted formaldehyde in the naphthalene-based condensate.

However, the method (1) not only hinders polymerization, but also requires the condensation time to be significantly prolonged for attaining a predetermined molecular weight. Because the condensation reaction is conducted generally in an aqueous system in production of a naphthalene condensate, the reaction temperature in the method (2) cannot be increased to a high temperature of 100 to 105° C. or more. In any of the methods (1) and (2), it is difficult to polymerize the condensate for attaining a suitable molecular weight for use as a cement dispersant, thus failing to attain predetermined dispersing performance and necessitating significant prolongation of the condensation time.

The present invention relates to provide a process capable of easily producing a water-soluble salt of a naphthalenesulfonate formaldehyde condensate reducing the amount of unreacted formaldehyde, having stabilized qualities, less burdening the environment with a load, and being suitable as a cement dispersant.

According to the present invention, there is provided a process capable of easily producing a water-soluble salt of a naphthalenesulfonate formaldehyde condensate reducing the amount of unreacted formaldehyde, having stabilized qualities, less burdening the environment with a load, and being suitable as a cement dispersant. Accordingly, there can be provided a water-soluble salt of a naphthalenesulfonate formaldehyde condensate reducing the amount of unreacted formaldehyde, having stabilized qualities, and less burdening the environment with a load, a cement dispersant containing the water-soluble salt, and a cement composition containing the dispersant.

Unlike the conventionally proposed methods (1) and (2) above, a method of removing unreacted formaldehyde as a water-insoluble material with a sulfite is proposed in the present invention.

That is, the present invention relates to a process for producing a naphthalenesulfonate formaldehyde condensate, including a condensation reaction step (I) of condensation reaction of naphthalenesulfonic acid with formaldehyde, a step (II) of adding a sulfite to a reaction system containing the condensate obtained in the condensation reaction step (I), and a step (III) of removing a water-insoluble material from the reaction system in the step (II), or to a process for producing a water-soluble salt of a naphthalenesulfonate formaldehyde condensate, including a condensation reaction step (I) of condensation reaction of naphthalenesulfonic acid with formaldehyde, a step (II) of adding a sulfite to a reaction system containing the condensate obtained in the condensation reaction step (I), and a step (III) of removing a water-insoluble material from the reaction system in the step (II) wherein neutralization of the condensate is carried out after the condensation reaction step (I); in this manner, after the conclusion of the condensation reaction of naphthalenesulfonic acid with formaldehyde, unreacted formaldehyde is removed as a water-insoluble material by adding a sulfite to the reaction system.

The sulfite selected in the present invention is excellent in the ability to form an insoluble material of formaldehyde and can exhibit an effect of sufficiently removing formaldehyde. Given other inorganic salts, such effect cannot be sufficiently attained. Accordingly, the amount of unreacted formaldehyde can be reduced without requiring a change in the condensation reaction conditions or prolongation of the condensation time. In the process of the present invention, an aqueous solution containing a water-soluble salt of a naphthalenesulfonate formaldehyde condensate dissolved therein can be obtained and thus used in many ways to serve preferably as a cement dispersant.

A water-soluble salt of a naphthalenesulfonate formaldehyde condensate with a formaldehyde content of 110 mg/kg or less can be obtained.

The sulfite used in the present invention is preferably a monovalent metal salt such as sodium salt or a divalent metal salt such as calcium salt or magnesium salt, among which the calcium salt is preferable from the viewpoint of removing formaldehyde as a water-insoluble material.

From the viewpoint of reaction efficiency, burden on a filtration step, and reduction in the amount of unreacted formaldehyde, the amount of the sulfite added is preferably 0.5 to 5 moles, more preferably 0.8 to 3 moles, further more preferably 1 to 3 moles, relative to 1 mole of unreacted formaldehyde present in the reaction system after the condensation reaction.

When a water-insoluble salt of the naphthalenesulfonate formaldehyde condensate is produced, it is preferable from viewpoints such as prevention of corrosion of a container that the neutralization of the condensate is carried out after the condensation reaction step (I). The neutralization is carried out preferably before the step (III). In the step (II), a neutralizing agent is preferably added together with the sulfite thereby forming a water-insoluble material of unreacted formaldehyde and simultaneously neutralizing the reaction system. From the viewpoint of preventing corrosion of a storing container, the neutralization is carried out preferably until the pH of the reaction system comes to be in the range of 4 to 12 at 20° C., and as the neutralizing agent, it is possible to employ calcium hydroxide, sodium hydroxide and calcium carbonate, among which calcium carbonate is preferable from the viewpoint of exhibiting the effect of the sulfite added (the effect of converting unreacted formaldehyde into a water-insoluble material). That is, the neutralizing agent is added preferably in 1.0 to 1.1 moles to 1 mole of naphthalenesulfonic acid, and is added preferably in 1.0 to 1.1 moles to 1 mole of the unreacted sulfuric acid. Such water-soluble salt is obtained usually as an aqueous solution in which the water-soluble salt was dissolved.

Hereinafter, one example of the process for producing a water-soluble salt of a naphthalenesulfonate formaldehyde condensate as a cement dispersant is briefly described.

First, for obtaining naphthalenesulfonic acid, sulfuric acid is used in a molar ratio of 1.2-1.4 moles to 1 mole of naphthalene, and reacted at 150 to 165° C. for 2 to 5 hours to give a sulfonated product. Then, 0.95 to 0.99 mole of formalin is added dropwise as formaldehyde to 1 mole of the sulfonated product at 85 to 95° C. over 3 to 6 hours, and subjected to condensation reaction at 95 to 105° C. [step (1)]. Water, a neutralizing agent (for example calcium carbonate) and sulfite are added to the condensate thereby neutralizing it at 80 to 95° C. and simultaneously converting unreacted aldehyde into a water-insoluble material [step (II) and neutralization]. The neutralizing agent is added preferably in 1.0- to 1.1-molar excess to naphthalenesulfonic acid and unreacted sulfuric acid respectively. The sulfite is added preferably in 0.5- to 5-molar excess relative to 1 mole of unreacted formaldehyde. The amount of unreacted formaldehyde in the reaction system can be measured according to a method described in the Examples below. Thereafter, in the step of removing a water-insoluble material in a conventional way, preferably by separation with filtration, [step (III)], an aqueous solution of a water-soluble salt of the naphthalenesulfonate formaldehyde condensate is obtained. This aqueous solution can be used as it is or as a cement dispersant composition to which other ingredients are suitably added. The solids content of the aqueous solution varies depending on use, and for use as a cement dispersant, the solids content is preferably 30 to 45 wt %. If necessary, the aqueous solution can be dried and powdered to give a powdered water-soluble salt of a naphthalenesulfonate formaldehyde condensate which can then be used as powdered cement dispersant. Drying and powdering can be carried out by spray drying, drum drying, freeze drying etc.

The weight-average molecular weight of the naphthalenesulfonate formaldehyde condensate or a water-soluble salt thereof, obtainable by the process of the present invention, is preferably 10000 or more, more preferably 10000 to 15000. This molecular weight is measured by liquid chromatography (with polystyrene sodium sulfonate as standard).

Water solubility referred to in a water-soluble salt of the naphthalenesulfonate formaldehyde condensate means that an aqueous solution having a solids content of 10 wt % or more can be prepared therefrom.

When the naphthalenesulfonate formaldehyde condensate is used as a cement dispersant, the amount of the condensate is preferably 0.05 to 3 parts by weight, more preferably 0.1 to 2 parts by weight, still more preferably 0.2 to 1 part by weight, relative to 100 parts by weight of cement.

By mixing the cement dispersant of the present invention with cement and water, a cement composition is obtained. The watercement ratio (W/C) is preferably 20 to 60%, more preferably 25 to 50%, still more preferably 30 to 45%.

The cement is cement such as ordinary portland cement, belite cement, moderate-heat portland cement, high-early-strength portland cement, ultla high-early-strength portland cement and sulfate-resistant cement, which may further contain blast furnace slag, fly ash, silica fume, lime stone powder (calcium carbonate powder) etc.

Further, the cement composition may contain aggregate. The aggregate includes sand and gravel. The hydraulic composition can be used as mortar and concrete.

The cement composition of the present invention can be used not only in the field of fresh concrete and vibrated concrete products but also in any fields of various kinds of concrete such as self-leveling concrete, refractory concrete, plaster concrete, gypsum slurry, lightweight or heavyweight concrete, AE concrete, repairing concrete, pre-packed concrete, tremie concrete, grout concrete, ground-improvement concrete, and concrete in the cold.

### EXAMPLES

The present invention is described by reference to the Examples below. The Examples are provided for merely illustrating the present invention and not intended to limit the present invention.

In the Comparative Examples and the Examples below, naphthalene-based condensate salts were produced and evaluated for their performance as cement dispersants. The results are shown in Table 1.

(Method of Measuring the Amount of Unreacted Formaldehyde)

The amount of unreacted formaldehyde in the reaction system was quantified by dissolving 1 g reaction product containing a naphthalene-based condensate (solids content 40 wt %) in 100 ml distilled water, then treating this aqueous solution to convert it into a 2,4-dinitrophenyl hydrazine derivative thereof and then quantify it by liquid chromatography. As the standard substance, a 2,4-dinitrophenyl hydrazine derivative of formaldehyde was used. The measurement conditions for liquid chromatography are as follows:

Column type: L-Column-ODS (4.6φ×150 mm)

Eluent: water/acetonitrile=1/1

Flow rate: 1.0 ml/min

Detector: UV 360 nm

(Molecular Weight of the Naphthalene-Based Condensate Salt)

The molecular weight of the naphthalene-based condensate salt, expressed in terms of weight-average molecular weight, was determined by preparing 0.2% aqueous solution thereof and measuring it by liquid chromatography. As the standard substance, polystyrene sodium sulfonate was used. The measurement conditions for liquid chromatography are as follows:

Column type: G4000SW_{XL}+G2000SW_{XL}(7.8φ×300 mm)

Eluent: 30 mM aqueous sodium acetate

solution/acetonitrile=6/4

Flow rate: 0.7 ml/min

Detector: UV 280 nm

(Evaluation of Performance as Cement Dispersant)

The performance of the naphthalene-based condensate salt as a cement dispersant was evaluated. 1000 g normal portland cement (manufactured by Taiheiyo Cement) and a solution prepared by dissolving, in 300 g water, the naphthalene-based condensate in an amount 1 wt % (in terms of solids content) relative to the cement were mixed with each other with a mortar mixer based on JIS-R5201 at low speed for 1 minute and at high speed for 2 minutes, and then introduced into a Vicat indentation cone. The surface of the cone surface was made even, and the spread (mm) after raising was measured.

### Comparative Example 1

44 g water was added to a sulfonated product obtained by reacting 1.28 moles of sulfuric acid with 1 mole of naphthalene at 150 to 160° C. for 3 hours, and then 0.98 mole (this amount of formalin is expressed in terms of the content of formaldehyde; this hereinafter applies) of (37%) formalin was dropped into it at 90° C. over 3 hours. After dropping, the condensation reaction was carried out at 98 to 102° C. for 10 hours. The resulting condensate was neutralized with water and a neutralization amount of calcium carbonate. After neutralization, the pH value was about 6. Thereafter, the reaction mixture was filtered, and the concentration of a calcium salt of the naphthalene-based condensate (referred to hereinafter as Ca salt) was adjusted to a solids content of 40 wt %. The amount of unreacted formaldehyde was 660 ppm (mg/kg), and the molecular weight of the Ca salt was 13200. The resulting aqueous solution was used as a cement dispersant to evaluate performance.

### Comparative Example 2

44 g water was added to a sulfonated product obtained by reacting 1.28 moles of sulfuric acid with 1 mole of naphthalene at 150 to 160° C. for 3 hours, and then 0.95 mole of (37%) formalin was dropped into it at 80 to 90° C. over 3 hours. After dropping, the condensation reaction was carried out at 98 to 102° C. for 10 hours. The resulting condensate was neutralized with water and a neutralization amount of calcium carbonate. After neutralization, the pH value was about 6. Thereafter, the reaction mixture was filtered to adjust the solids content of the Ca salt to 40 wt %. The amount of unreacted formaldehyde was 450 ppm (mg/kg), and the molecular weight of the Ca salt was 8500. The resulting aqueous solution was used as a cement dispersant to evaluate performance.

### Comparative Example 3

44 g water was added to a sulfonated product obtained by reacting 1.28 moles of sulfuric acid with 1 mole of naphthalene at 150 to 160° C. for 3 hours, and then 0.95 mole of (37%) formalin was dropped into it at 90° C. over 3 hours. After dropping, the condensation reaction was carried out at 98 to 102° C. for 18 hours. The resulting condensate was neutralized with water and a neutralization amount of calcium carbonate. After neutralization, the pH value was about 6. Thereafter, the reaction mixture was filtered to adjust the solids content of the Ca salt to 40 wt %. The amount of unreacted formaldehyde was 410 ppm (mg/kg), and the molecular weight of the Ca salt was 11100. The resulting aqueous solution was used as a cement dispersant to evaluate performance.

### Comparative Example 4

44 g water was added to a sulfonated product obtained by reacting 1.28 moles of sulfuric acid with 1 mole of naphthalene at 150 to 160° C. for 3 hours, and then 0.98 mole of (37%) formalin was dropped into it at 90° C. over 3 hours. After dropping, the condensation reaction was carried out at 98 to 102° C. for 18 hours. The resulting condensate was neutralized with water and a neutralization amount of calcium carbonate. After neutralization, the pH value was about 6. Thereafter, the reaction mixture was filtered to adjust the solids content of the Ca salt to 40 wt %. The amount of unreacted formaldehyde was 440 ppm (mg/kg), and the molecular weight of the Ca salt was 16300. The resulting aqueous solution was used as a cement dispersant to evaluate performance.

### Comparative Example 5

After condensation reaction was carried out by the synthesis method in Comparative Example 1, the resulting condensate was neutralized with water, a neutralization amount of calcium carbonate, and sodium carbonate in an amount corresponding to the amount of unreacted formaldehyde shown in Table 1. After neutralization, the pH value was about 6. Thereafter, the Ca salt was filtered and adjusted in the same manner as in Comparative Example 1 to have a solid content of 40 wt %. The amount of unreacted formaldehyde and the molecular weight of the condensate salt are shown in Table 1. The resulting aqueous solution was used as a cement dispersant to evaluate performance.

### Examples 1 to 9

After condensation reaction was carried out by the synthesis method in Comparative Example 1, the resulting condensate was neutralized with water, a neutralization amount of calcium carbonate, and the type of sulfite shown in Table 1 and sulfite in an amount corresponding to the amount of unreacted formaldehyde in Table 1. After neutralization, the pH value was about 6. Thereafter, the Ca salt was filtered and adjusted in the same manner as in Comparative Example 1 to a solids content of 40 wt %. The amount of unreacted formaldehyde and the molecular weight of the condensate salt are shown in Table 1. The resulting aqueous solution was used as a cement dispersant to evaluate performance.

TABLE 1

| | | | Compound added after | | | |
|---|---|---|---|---|---|---|
| | | Amount of | condensation reaction | | | |
| | | unreacted | | Added | | Dispersing |
| | | formaldehyde(ppm | | amount | Molecular | performance |
| | | or mg/kg) | Kind | (moles) | weight | (mm) |
| Comparative | 1 | 660 | — | — | 13200 | 253 |
| example | 2 | 450 | — | — | 8500 | 194 |
| | 3 | 410 | — | — | 11100 | 223 |
| | 4 | 440 | — | — | 16300 | 245 |
| | 5 | 650 | Sodium carbonate | 1.0 | 13200 | 252 |
| Example | 1 | 45 | Calcium sulfite | 0.8 | 13100 | 254 |
| | 2 | 18 | Calcium sulfite | 1.0 | 13400 | 251 |
| | 3 | 19 | Calcium sulfite | 1.5 | 13500 | 257 |
| | 4 | 18 | Calcium sulfite | 2.0 | 13200 | 253 |
| | 5 | 21 | Calcium sulfite | 3.0 | 13700 | 250 |
| | 6 | 23 | Calcium sulfite | 5.0 | 13100 | 258 |
| | 7 | 32 | Magnesium sulfite | 1.0 | 13300 | 255 |
| | 8 | 105 | Sodium sulfite | 1.0 | 13200 | 252 |
| | 9 | 43 | Sodium sulfite | 1.5 | 13400 | 254 |

*In Table 1, the amount of sulfite added is an amount (moles) per mole of unreacted formaldehyde.

1. A process for producing naphthalenesulfonate formaldehyde condensate, comprising a condensation reaction step (I) of condensation-reacting naphthalenesulfonic acid with formaldehyde, a step (II) of adding a sulfite to the reaction system comprising the condensate obtained in the condensation reaction step (I), and a step (III) of removing a water-insoluble material from the reaction system in the step (II).

2. A process for producing a water-soluble salt of a naphthalenesulfonate formaldehyde condensate, comprising a condensation reaction step (I) of condensation-reacting naphthalenesulfonic acid with formaldehyde, a step (II) of adding a sulfite to the reaction system comprising the condensate obtained in the condensation reaction step (I), and a step (III) of removing a water-insoluble material from the reaction system in the step (II), neutralization of the condensate being carried out after the condensation reaction step (I).

3. The process according to claim 1 or 2, wherein the sulfite is a divalent metal salt.

4. The process according to claim 1 or 2, wherein the sulfite is added in an amount of 0.5 to 5 moles per mole of unreacted formaldehyde.

5. A naphthalenesulfonate formaldehyde condensate or a water-soluble salt thereof, which is obtainable by the process of claim 1.

6. A naphthalenesulfonate formaldehyde condensate or a water-soluble salt thereof, which is obtainable by the process of claim 2.

7. A cement dispersant comprising the water-soluble salt of a naphthalenesulfonate formaldehyde condensate according to claim 5.

8. A cement dispersant comprising the water-soluble salt of a naphthalenesulfonate formaldehyde condensate according to claim 6.

9. A cement dispersant comprising a naphthalenesulfonate formaldehyde condensate containing formaldehyde in an amount of 110 mg/kg or less and having a weight-average molecular weight of 10000 or more, or a water-soluble salt thereof.

10. A cement composition comprising cement, water and the cement dispersant of any one of claim 7 to 9.

11. A process for producing a cement dispersant, comprising a condensation reaction step (I) of condensation-reacting naphthalenesulfonic acid with formaldehyde, a step (II) of adding a sulfite to the reaction system comprising the condensate obtained in the condensation reaction step (I), and a step (III) of removing a water-insoluble material from the reaction system in the step (II) neutralization of the condensate being carried out after the condensation reaction step (I).
